(19) United States
(12) Patent Application Publication
(10) Pub. No.: US 2001/0012343 A1
(43) Pub. Date: Aug. 9, 2001

(54) SYSTEM AND METHOD FOR REDIRECTING LONG DISTANCE TRANSMISSIONS OVER A COMPUTER NETWORK

(76) Inventor: GUIDO DAL MOLIN, NAPLES, FL (US)

Correspondence Address: MR. GUIDO DAL MOLIN, 227 PALM DRIVE, APT #2, NAPELS,, FL, 33942, US

(21) Appl. No.: 09/357,039

(22) Filed: Jul. 20, 1999

Related U.S. Application Data
(60) Provisional application No. 60/093,374, filed on Jul. 20, 1998.

(51) Int. Cl. H04M 11/00; H04N 1/00

(52) U.S. Cl. 379/100.12; 379/93.05; 379/93.07; 358/400

(57) ABSTRACT

A method and system for redirecting long distance telephone transmissions makes use of computer hardware and software to run a network that allows transmission of telephonic messages, such as facsimile messages or alarm system related messages, through a wide area computer network, such as the Internet. The system includes, for example, one or more routers and a centralized communications center server. A telephonic message directed to an intended destination is received by the system, which sends the message over the network to the centralized communications center server. The server automatically directs the message according to the intended destination over the network.

### CROSS REFERENCE TO RELATED APPLICATIONS

This application claims the benefit of U.S. Provisional application Ser. No. 60/093,374 filed Jul. 20, 1998.

### FIELD OF THE INVENTION

The present invention relates generally to long distance transmission systems and, in particular, to a system and method for redirecting long distance transmissions, such as facsimile transmissions, or long distance alarm transmissions and alarm related data over a computer network, such as the Internet.

### BACKGROUND OF THE INVENTION

Currently, there are systems for sending facsimiles through wide area computer networks, such as the Internet, but there is no way for these wide area computer networks to receive facsimiles from a standard, dedicated facsimile machine. Instead, the facsimiles must be generated by electronic mail. There is also currently software that will deliver facsimiles from electronic mail to a facsimile machine. However, there is no way of getting a facsimile into a wide area computer network, such as the Internet, from a standard facsimile machine.

Wide area computer networks, such as the Internet, can now be accessed virtually worldwide. As used in this application, the phrase “computer network” refers primarily to wide area networks, but also includes metropolitan area and other computer networks to the extent that long distance telephone calls can be made between users within the geographic region covered by the network.

A network service provider is one who has a high speed data line in communication with another network provider that may be, for example, somewhere else in the country. For example, a plurality of different network service providers can all be connected to each other through high speed data lines. In a typical network, such as the Internet, companies like SPRINT and AT&T have large computers that provide digital switching to put people on-line with each other.

Local service providers typically provide network access service for a given billing rate to people within their area. The access service can be provided through normal telephone lines provided by a local telephone company. It can be either through leased lines, which means renting a line from that provider, for example, directly to a building, or through a leased telephone line, which means 24 hour-a-day service on an installed telephone line from that provider to the building; or through what is called dial-up lines, which are essentially the same as the telephone service connected to any telephone in a home or business.

Call diverter devices exist that monitor digits dialed by a telephone and either block or redirect the intended call based on how the device is programmed. For example, when a 1-plus number is dialed (i.e., a long-distance number), the call diverter device can disconnect the call and put it right back to a dial tone. This device can block any 1-plus calls and return calls to a dial tone every time an attempt is made to dial a 1-plus number. This device can be programmed to accept a password entered either before or after dialing a number to allow the call to go through. The device can also disconnect a 1-plus call and dial the same area code and phone number starting with a zero to take the call through an operator.

In the field of alarm-related monitoring systems, currently two of the most significant operating costs associated with a central monitoring station are labor and toll charges. One of the functions of the central monitoring station is to provide a dealer, which performs various alarm-related contracting services to subscribers, with detailed reports of the subscribers' alarm history, which, in most cases, is then passed on to the subscribers. Also, from time to time, the dealer is required to make changes or update a subscriber's information that is stored within the alarm processing equipment located at the central monitoring station.

In many cases the subscriber's alarm system must be programmed to dial a 1-plus toll call in order to transmit signals to the central monitoring station. Additionally, the subscribers must also dial a 1-plus toll call to contact central monitoring station personnel or automated alarm processing equipment of the central monitoring station. This equipment may be used by the subscriber or the dealer to produce voice-on-demand or fax-on-demand reports of various types of dealer or subscriber account information. In the case of the latter, the automation system of the central monitoring station must dial a 1-plus toll call to transmit the facsimile from the central monitoring station to the subscriber's or dealer's facsimile machine.

Currently, there are systems for a central monitoring station to receive and process alarm signals that are transmitted from subscribers' alarm systems using standard telephone lines, but there is no way to receive the alarm signal and redirect the transmission over a computer network, such as the Internet. Wide area computer networks, such as the Internet, can now be accessed virtually worldwide. As used in this application, the phrase “computer network” refers primarily to wide area networks, but also includes metropolitan area, virtual private networks and other computer networks, to the extent that long distance telephone calls can be made between users within the geographic region covered by the network.

A network service provider is one who has a high speed data line in communication with another network provider that may be, for example, somewhere else in the country. For example, a plurality of different network service providers can all be connected to each other through high speed data lines. In a typical network, such as the Internet, companies like SPRINT and AT&T have large computers that provide digital switching to put people on-line with each other.

Local service providers typically provide network access service for a given billing rate to people within their area. The access service can be provided through normal telephone lines provided by a local telephone company. It can be either through leased lines, which means renting a telephone line that has 24-hour-a-day service from that provider, for example, directly to a building, or through what is called dial-up lines, which are essentially the same as telephone service connected to any telephone in home or business.

### SUMMARY OF THE INVENTION

It is a feature and advantage of the present invention to provide a method and system for redirecting long distance transmissions which reduces manpower requirements and associated labor costs, for example, for long distance facsimile or alarm related transmissions.

It is a further feature and advantage of the present invention to provide a method and system for redirecting long distance transmissions, such as long distance facsimile or alarm related transmissions, which virtually eliminates all toll charges for such transmissions.

It is an additional feature and advantage of the present invention to provide a method and system for redirecting long distance transmissions, such as long distance facsimile or alarm related transmissions, which offers a user far more value, features, and services at a cost lower than can be achieved using presently available technology.

An embodiment of the present invention provides a method and system for redirecting long distance facsimile transmissions which makes use of computer hardware and software to run a network that allows a facsimile machine to send a facsimile through a wide area computer network, such as the Internet, to any other facsimile machine without long-distance charges. In other words, an embodiment of the present invention uses existing computer networks, such as the Internet, to route facsimile data from one point to another, without using any other long-distance lines. As used herein, the term “local calling area” refers to a city, town, or other geographic area whose telephone calls are all local to each other. Anyone can send or receive a phone call within a local calling area without incurring any long-distance charges.

In an embodiment of the present invention, a router is set up in the cities of each local calling area in which the system for an embodiment of the present invention will be used. The router for an embodiment of the present invention is essentially a computer with incoming and outgoing phone lines and telephone modems that determines the path of network traffic flow. A main billing center or main control station is connected to the computer network for handling accounts and billing. The main control station also validates accounts and permits administrative work to be performed on individual accounts.

In a facsimile transmission aspect for an embodiment of the present invention, a “faxbox” is provided that is essentially an enhanced call diverter box. Any person who wishes to send a facsimile for free is required to put a faxbox on the phone line of that person's facsimile machine. Whenever the person attempts to dial a long-distance number, the faxbox then routes the long-distance call to the router, which is that computer set up in the person's local calling area, and the router receives the facsimile.

In an embodiment of the present invention, at the point that the router is contacted by a faxbox with a long-distance facsimile to send, the router contacts the main central station and validates that the sender's account is in good standing and that the destination of the facsimile is within an area to which the sender is authorized to send a facsimile. Upon validation of the sender's account, the router in the local calling area communicates with the facsimile machine and receives the facsimile. The facsimile is then directed to a router in a different calling area—the local calling area of the destination of the facsimile.

In short, in an embodiment of the present invention, a local router picks up a facsimile from a sender's facsimile machine, contacts central headquarters for the network address of a router in the local calling area of the receiving facsimile machine, and then, if everything is in good standing, the facsimile is passed on to the router in the receiver's local calling area. The receiving router then dials a local number for the person to whom the facsimile is intended and delivers the facsimile through a telephone modem to the receiving facsimile machine.

An important feature of the facsimile aspect of an embodiment of the present invention is the faxbox attached to the telephone line of the sender's facsimile machine for the purpose of detecting and re-directing long-distance calls. The faxbox is preferably powered by a telephone line, and remotely programmable for a variety of dialing and call routing options.

Another aspect of an embodiment of the present invention provides a method and system for redirecting long distance transmissions, such as alarm transmissions and alarm related data over a computer network. The alarm transmission aspect for an embodiment of the present invention utilizes hardware and software to run the network that allows central monitoring stations to communicate with their dealers and subscribers over a computer network, such as the Internet, in a method whereby data is exchanged over the computer network that previously would have required a long-distance telephone call.

An embodiment of the present invention makes use of hardware and software to run the network that allows alarm signals to be received within a calling area that is local to alarm dealers and subscribers, but is long-distance to the central monitoring station, and to redirect these alarm signals through a wide area computer network, such as the Internet, to the alarm processing equipment located at the central monitoring station. Additionally, an embodiment of the present invention provides a method and system whereby telephone calls can be made from the central monitoring station.

An embodiment of the present invention makes use, for example, of a router that is set up in the cities of each local calling area in which there are subscribers' accounts that are to be monitored by the central monitoring station. A router is essentially a computer with incoming and outgoing phone lines and telephone modems that determines the path of network traffic flow. A main control station and billing center is connected to the computer network for handling accounts, billing, and network management. The main control station also validates accounts and permits administrative work to be performed on individual accounts. In an embodiment of the present invention, the router is essentially a computer that acts as an interface between a group of standard telephone lines within a local calling area, and a computer network, such as the Internet.

To achieve the stated and other features, advantages and objects, an embodiment of the present invention utilizes computer hardware and software, such as telephone receivers, facsimile machines, personal computers with modems, faxboxes, servers and the like. The system for an embodiment of the present invention receives a telephonic message directed to an intended destination, automatically associates the message with a sender account, and automatically directs the message according to a long distance aspect of the message to the intended destination over a computer network.

In an embodiment of the present invention, a telephonic message directed to an intended destination is received by a local router, for example, from a facsimile machine coupled to a faxbox or directly, for example, from an alarm related terminal, such as an alarm system or an alarm system subscriber or alarm system dealer telephone. In the case of a facsimile machine message, the faxbox automatically identifies the long distance aspect, automatically stores information related to the long distance aspect, automatically interrupts a telephone line to the facsimile machine, and automatically establishes communication to the local router.

The faxbox for an embodiment of the present invention automatically transmits information related to the intended destination to the local router which, in turn, automatically establishes communication to a centralized communications center server. The local router automatically forwards the intended destination information to the centralized communications server, which automatically verifies the long distance aspect from the intended destination information.

The faxbox for an embodiment of the present invention also stores sender account information related to the facsimile message and automatically transmits the account information to the local router. The local router likewise automatically forwards the account information to the centralized communications center server. The centralized communications center server automatically verifies the sender account according to the account information. In the case of an alarm related message, the local router receives the account information direct from the alarm related terminal and likewise forwards the account information to the centralized communications center server.

In an embodiment of the present invention, in the case of a facsimile message, upon verification of the sender account, the message is transmitted from the local facsimile machine to the local router, which transmits the message over the network to the central communications center server. In turn, the central communications center server transmits the message over the network to a remote router, which transmits the message to a remote facsimile machine. The remote router sends a status report of the received message to the centralized communications center server, which forwards the status report to the local facsimile machine.

In an embodiment of the present invention, information related to the sender account is automatically transmitted over the computer network by the centralized communications server to the local router in response to a request for the information by the centralized communications server from the local router. In turn, the information is formatted by the local router automatically converts the information from text to voice format and transmits the information to a telephone receiver or automatically converts the information from text to facsimile format and transmits the information to a facsimile machine.

In an embodiment of the present invention, in the case of an alarm signal message, such as an alarm signal, the local router automatically transmits an alarm message over the computer network to the centralized communications server. The centralized communications server automatically processes the alarm message and automatically transmits an alarm system call-back message over the computer network to the local router. In turn, the local router automatically transmits the alarm system call-back message to a telephone receiver, for example, of an alarm system subscriber or an alarm system dealer.

Additional objects, advantages and novel features of the invention will be set forth in the description which follows, and in part will become more apparent to those skilled in the art upon examination of the following, or may be learned by practice of the invention.

### BRIEF DESCRIPTION OF THE DRAWINGS

FIG. 1 is a schematic flow chart which illustrates an overview of key components and the flow of information between the key components of a transmission system for an embodiment of the present invention;

FIG. 2 is a schematic flow chart which amplifies and provides further detail regarding an example of key components and the flow of information between key components within the local calling areas shown in FIG. 1 for a facsimile transmission aspect of an embodiment of the present invention;

FIG. 3 is a schematic flow chart which amplifies and provides further detail regarding examples of key components and the flow of information shown in FIGS. 1 and 2 for the facsimile transmission aspect of an embodiment of the present invention;

FIG. 4 is a flow chart which illustrates an example of the facsimile transmission aspect process for an embodiment of the present invention;

FIG. 5 is a schematic flow chart which amplifies and provides further detail regarding an example of key components and the flow of information between key components within the local calling areas shown in FIG. 1 for an alarm transmission aspect of an embodiment of the present invention;

FIG. 6 is a schematic flow chart which amplifies and provides further detail regarding examples of key components and the flow of information between key components shown in FIGS. 1 and 5 for the alarm-related transmission aspect of an embodiment of the present invention;

FIG. 7 is a flow chart which illustrates an example of the account information access process for the alarm-related aspect of an embodiment of the present invention;

FIG. 8 is a flow chart which illustrates an example of the call back false alarm verification process for the alarm-related transmission aspect of an embodiment of the present invention;

FIG. 9 is a table which illustrates an example of programming of the fax box for an embodiment of the present invention;

FIGS. 10 and 11 are detailed schematics of examples of electrical circuitry for the fax box for use in an embodiment of the present invention; and

FIGS. 12 and 13 are schematic drawings showing an example of a circuit board layout of the fax box for use in an embodiment of the present invention.

### DETAILED DESCRIPTION

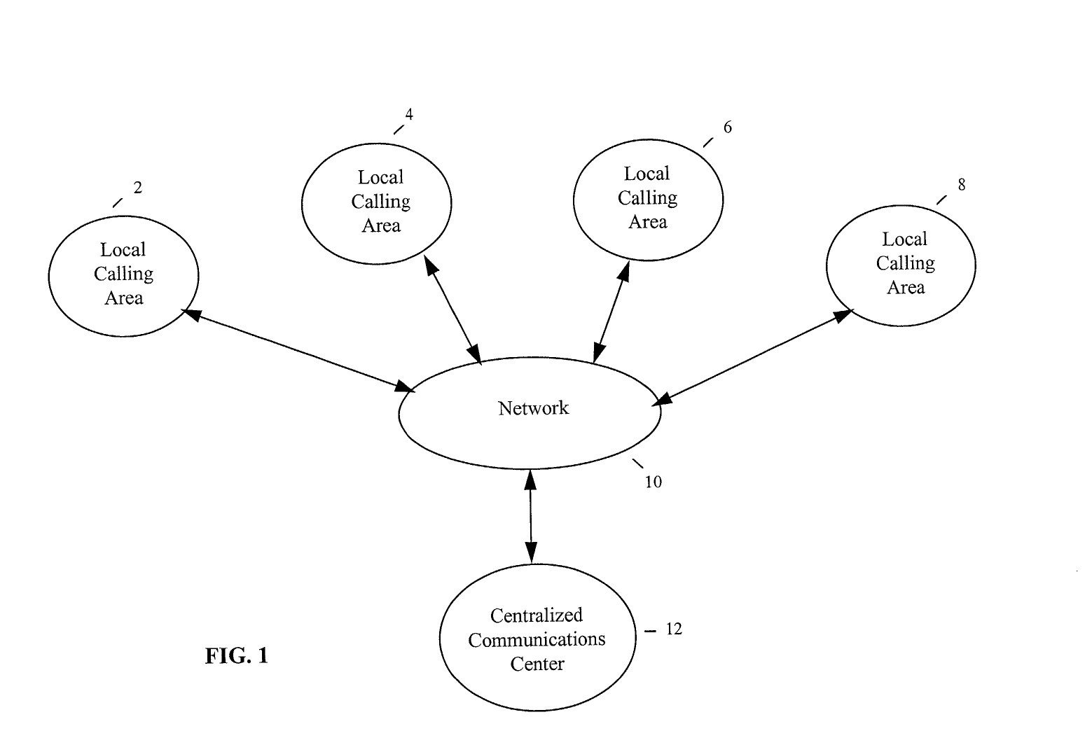

Referring now made in detail to an embodiment of the present invention, an example of which is illustrated in the accompany drawings, FIG. 1 is a schematic flow chart which illustrates an overview of an example of key components and the flow of information between the key components for a transmission system for an embodiment of the present invention. Referring to FIG. 1, an embodiment of the present invention includes, for example, one or more local calling areas, such as local calling areas 2, 4, 6, and 8, which can be coupled over a network 10, such as the Internet, to one another via a centralized communications center 12. In an embodiment of the present invention, the terms “local calling area” and “centralized communications center” have certain meanings and/or functions as explained more fully herein.

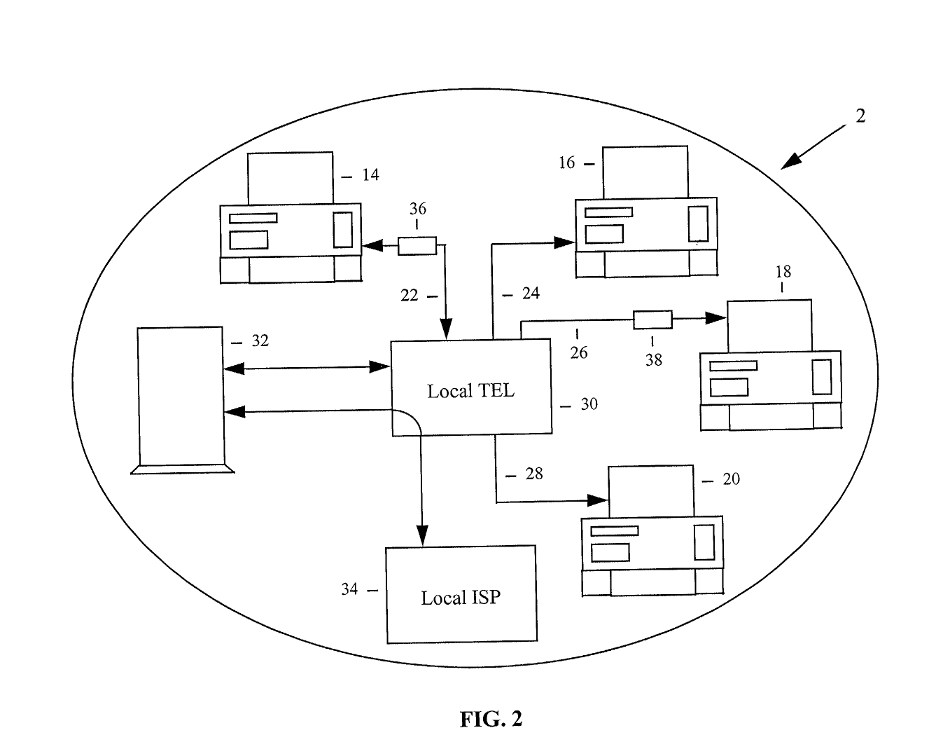

FIG. 2 is a schematic flow chart which amplifies and provides further detail regarding an example of key components and the flow of information between key components within the local calling areas shown in FIG. 1 for a facsimile transmission aspect of an embodiment of the present invention. While FIG. 2 illustrates examples of key components and the flow of information between the key components for local calling area 2, FIG. 2 is likewise illustrative of examples of the other local calling areas, such as local calling areas 4, 6, and 8, shown in FIG. 1.

Referring to the example of local calling area 2 shown in FIG. 2, each local calling area includes, for example, one or more facsimile machines 14, 16, 18, and 20, connected via telephone lines 22, 24, 26, and 28 respectively to a local telephone system 30. Each local calling area also includes, for example, at least one router 32 and at least one network service provider 34. Referring further to the example of local calling area 2 shown in FIG. 2, as used herein, a faxbox, such as faxboxes 36 and 38, is a piece of customer-based hardware which attaches, for example, to the telephone line, such as telephone lines 22 and 26, of an originating facsimile machine, such as facsimile machines 14 and 18, respectively. The term local calling area is used herein to describe an area, such as local calling areas 2, 4, 6, and 8 shown in FIG. 1, whose telephone numbers can be dialed without toll charges.

Referring again to the example of local calling area 2 shown in FIG. 2, in an embodiment of the present invention, the term router, such as router 32, means the equipment located within the local calling area, whose basic function is to provide SEND/RECEIVE facsimile capability, including receiving facsimiles directed to it, for example, from a local faxbox, such as faxboxes 36 and 38 of facsimile machines 14 and 18 respectively, and sending facsimiles to any facsimile machine, such as facsimile machines 16 and 20, within the router's local calling area. The router 32 can consist, for example, of a commercially available industrial personal computer (PC) and multiple custom developed telephone modem-like devices called line cards.

Referring still further to the example of local calling area 2 in FIG. 2, in an embodiment of the present invention, the router 32 must be connected, for example, to at least two telephone lines, such as any two of telephone lines 22, 24, 26, or 28, but can be connected, for example, to up to 64 lines or more to meet the increased demands of the local calling traffic. One line card is required for each telephone line. Multiple routers can be used within the same local calling area, if one router cannot adequately meet the area's demands.

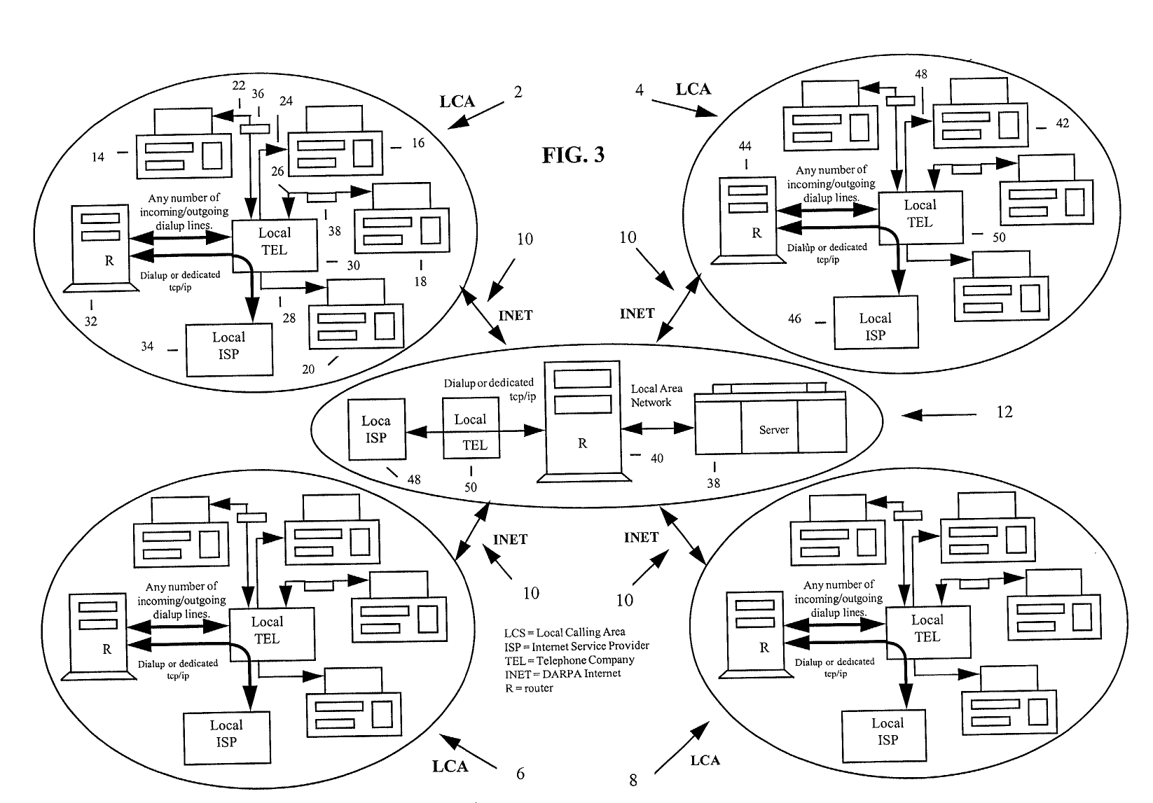

FIG. 3 is a schematic flow chart which amplifies and provides further detail regarding examples of key components and the flow of information shown in FIGS. 1 and 2 for the facsimile transmission aspect of an embodiment of the present invention. The centralized communications center 12 includes, for example, the central office, computer equipment, and personnel required to manage all network operations for an embodiment of the present invention. Referring to FIG. 3, the centralized communications center 12 has, for example, central computer equipment and a database 38, the primary function of which is to manage all point-to-point communication between all routers and to handle client-related administrative operations, such as accounting, usage limitations, and faxbox initialization, including without limitation, activation and deactivation.

Referring further to the example of local area 2 in the facsimile transmission aspect for an embodiment of the present invention, a faxbox, such as faxbox 36 or 38, attached to telephone line 22 or 26 respectively of the sender's facsimile machine 14 or 18, is used to monitor all outgoing numbers dialed on the sender's facsimile machine. The faxbox 36 or 38 can be programmed remotely to detect certain types of calls, for example, a 1-plus call, such as a 1-800 call or a 1-900 call, or a 0-plus call.

In an embodiment of the present invention, using the example of local area 2, the faxbox, such as faxbox 36 or 38, can be programmed to route a facsimile through the network 10 on a variety of different types of calls. For example, faxbox 36 or 38 can be programmed to route a facsimile through the network 10 upon detection of any 1-plus calls, or only 1-plus calls to a certain area code, or certain areas can be blocked. Thus, faxbox 36 or 38 can be programmed in such a way that any number of dialing features can enable or disable calls on that particular box.

In an embodiment of the present invention, again using the example of local area 2, the faxbox itself, such as faxbox 36 or 38, is telephone line powered, which means no other power source is needed except the phone line 22 or 26 respectively to operate the faxbox. The faxbox, such as faxbox 36 or 38, has non-volatile memory, so that once it is programmed, it does not need constant communication with a phone line to remember how it was programmed. Each faxbox, such as faxbox 36 or 38, is set up with an account number and, if need be, that faxbox can be deactivated remotely or through the main billing system for non-payment and so forth.

In an embodiment of the present invention, a local calling area, such as local calling areas 2, 4, 6, or 8, is an area whose phone calls are all local to each other. A router, such as router 32 for local area 2, or corresponding routers for local areas 4, 6, and 8, is set up in a city of each local calling area that can be contacted from the centralized communications center 12. That router, such as router 32 for local area 2, or the corresponding routers in other local calling areas, such as local calling areas 4, 6, and 8, provides service to those people within that particular local calling area. For example, space can be rented, either in the local telephone company or inside an office, to set up the routers for the various local calling areas 2, 4, 6, and 8.

In an embodiment of the present invention, using the example of local calling area 2, router 32 uses its modems to make and receive calls through a local telephone company 30 and calling a local number to a network service provider (e.g., an Internet service provider) 34 that sells network access time for a given rate. For example, in local calling area 2, the router 32 can dial a seven-digit local number and contact the network service provider 34 through the local telephone company 30. The line can be available 24 hours a day with that network provider 34 or, if need be, the local router 32 can be programmed to shut down upon a certain inactivity time. The same is true for the corresponding routers in other local calling areas, such as local calling areas 4, 6, and 8.

In an embodiment of the present invention, if no one tries to send a facsimile to or from a particular local calling area or city, such as local calling area 2, within a certain amount of time, the router 32 in that local calling area disconnects from the local network service provider, such as network service provider 34. Network service providers (e.g., Internet service providers) often charge a basic charge, for example, $20 a month or $50 a month, and bill per hour after that. The router, such as router 32, can be programmed to disconnect from the local network service provider, such as network service provider 34, and go on line only if someone sends a facsimile to that router.

In sending a facsimile according to an embodiment of the present invention, using the example of local calling area 2, the faxbox, such as faxbox 36 or 38, on the sending facsimile machine, such as facsimile machine 14 or 18 respectively, first detects whether the call is a local call or a long-distance call. As mentioned above, a long-distance call can be detected, for example, by detecting a 1-plus call, a telephone number having a certain number of digits, or a particular long-distance number.

In an embodiment of the present invention, referring to the example of local calling area 2, the faxbox 36 or 38 records and stores the dialed number in its memory. The faxbox 36 or 38 then disconnects the sender's facsimile machine 14 or 18 respectively from the telephone company 30 and dials a number that is pre-programmed into the facsimile machine—the number of local router 32 for the city of that calling area, such as local calling area 2 for the present example. The faxbox 36 or 38 then communicates with the local router 32 and identifies itself by transmitting an account number to the router.

At the point that the local router 32 for local area calling area 2 for an embodiment of the present invention has validated the account and/or the customer number, the local router then allows the facsimile machine 14 or 18 to send the facsimile to that router, and the router accepts the facsimile. At that point, the local router 32 transmits the facsimile through the network service provider 34 over the network 10 to a different router in a different city, such as one of local calling areas 4, 6, or 8, based on the destination given by the centralized communications center 12.

In an embodiment of the present invention, the main server 38 of the centralized communications center 12 communicates with the computer network 10 through its own local router 40. At the point the router 32 in the sender's local calling area 2 contacts the main server's router 40, the sender's router communicates to the main server 38 what the customer's number is that it wishes to validate, and also identifies the destination facsimile machine, such as, for example, facsimile machine 42 in local calling area 4. If service is provided to that particular destination, the server 38 informs the sending router 32 of the address of the receiving router 44, and then the sending router contacts the receiving router directly through the local network service provider (ISP) 46 for local calling area 4.

In an embodiment of the present invention, the centralized communications center 12 also ties into the computer network 10 through a local service provider 48. Thus, the centralized communications center 12 can be anywhere that service to the network 10 is provided. The sending router 32 for local calling area 2 contacts the server 38 for the centralized communications center 12, through its local telephone company 30 over the phone lines through the local network service provider 34, to the local network service provider 48 at the centralized communications center, through the local phone company 50 for the centralized communications center. The account is validated, and if it is valid, and if service is available to the destination where the facsimile is going, such as local calling area 4, the sending router 32 is given the network address.

In an embodiment of the present invention, the network address is like a telephone number—each router has its own address on the network. The sending router 32 in local calling area 2 is supplied with the information that it needs to contact the receiving router 44 in local calling area 4 for delivering the facsimile directly. Assuming that the account is valid, the network address is handed back to the router 32 that is receiving the facsimile from the facsimile machine, such as facsimile machine 14 or 18, of local calling area 2. At the point that the sending router 32 in local calling area 2 completes receiving the fax, it then turns around, contacts the receiving router 44 in the city of the destination in local calling area 4, sends the facsimile to that router, again, through the network 10, and the facsimile arrives at the receiving router through the local network service provider 46 in local calling area 4.

In an embodiment of the present invention, when the router 44 in the destination city, such as local calling area 4, receives the fax, it is also given the telephone number that was originally received by the faxbox, such as faxbox 36 or 38, in local calling area 2. All of that information is passed along, so that the receiving router 44 knows the telephone number it has to contact. The receiving router 44 strips off any 1-plus information and strips off any area code (if appropriate), leaving only a local seven-digit telephone number.

The receiving router 44 for an embodiment of the present invention then uses one of the telephone lines, such as telephone line 48, provided to it by the local telephone company 49 in local calling area 4, dials the local telephone number for the receiving facsimile machine 42 of the person who is about to receive the fax, and then delivers the facsimile. A faxbox is not needed in order to receive a facsimile from the system, for example, by receiving facsimile machine 42. The faxbox is necessary only to send a facsimile into the system. Basically, as long as service is provided within a given city, a facsimile can be sent to anybody who has a facsimile machine.

Using the example of local calling area 2, the faxbox, such as faxbox 36 or 38, for an embodiment of the present invention has a number of additional features. For example, if a person dials a 1-900 number, or calls someplace where service is not provided, the router 32 in the sender's local calling area 2 that would normally receive the facsimile can be instructed to tell the faxbox, such as faxbox 36 or 38, to hang up and place the call as normal, just as though it were direct dial from the facsimile machine, such as facsimile machine 14 or 18, respectively. So, if an account is not in good standing, or if the call is to a 1-900 number, or to someplace where service is not provided, the call can either be completely disconnected, or the number can be dialed straight out as though the faxbox was not there.

Another feature built into the faxbox for an embodiment of the present invention is its capacity to monitor the phone line, even when the associated facsimile machine is not turned on. For remote programming of the faxbox, it can be programmed to answer the phone after a predetermined number of rings, such as eight rings. Thus, as long as the faxbox is plugged in, even if the associated facsimile machine does not answer the phone, the faxbox will answer after eight rings. Once the faxbox goes off hook, it sends a tone to the local router, and then can be programmed, deactivated, the call parameters changed (e.g., to look for a one or zero), or any other parameters in the faxbox can be changed.

Facsimiles are routed, for example, through some components of the system for an embodiment of the present invention and are stored in other components. There is a distinction between being routed through and being stored. Except for transferring the call, the faxbox itself is essentially invisible to the system. The faxbox itself does not actually receive a facsimile. Likewise, if a facsimile goes through a local telephone company, it only goes through the telephone company by using a telephone line; it does not get stored at the phone company either. The local faxbox reads and diverts the number dialed and communicates with the local router.

The faxbox for an embodiment of the present invention is, in some ways, like a telephone call diverter. When a particular type of number is dialed, the faxbox sends the call to a different number. For example, to send a facsimile from the sending facsimile machine to a receiving facsimile machine having a telephone number 1-700-000-9999, instead of dialing 1-700-000-9999, the faxbox associated with the sending facsimile machine disconnects the call and calls the 7-digit number of the local router. The facsimile is then sent to the local router and is stored in the local router until it is completely received.

Using sending facsimile machine 14 in local calling area 2 and receiving facsimile machine 42 in local calling area 4 as an example, before the faxbox 36, for an embodiment of the present invention, is allowed to send the facsimile from the sending facsimile machine, the sending router 32 first contacts the centralized communications center 12 to validate the sender's account. From the time the receiver of the sending facsimile machine is lifted off-hook, the faxbox 36 monitors the phone line. The faxbox 36 starts monitoring right from the beginning, as soon as a call is started. If the faxbox 36 detects the completion of a 1-plus call, for example, it shuts off the telephone service to the sending facsimile machine 14, which is just like unplugging the phone line on the facsimile machine. The sending facsimile machine 14 has completed the dialing process and is now waiting to hear tones for the answering facsimile machine and is unaware that this will be interrupted.

During the time that the telephone line to the sending facsimile machine 14 is disconnected, the faxbox 36, for an embodiment of the present invention, is talking to the sending router 32, saying, for example, “I'm customer number so-and-so, am I valid?” and so forth. The local router 32 does not contain this information, so the router has to contact the main server 38 at the centralized communications center 12 to find out if that customer is valid. So, at this point the telephone line at the sending facsimile machine 14 is disconnected, the number was dialed, and there is silence on the facsimile machine. At the same time, the faxbox 36 is talking to the local router 32 asking if its account number is valid or not.

Assuming that the customer's information is validated, the next thing that the sending router 32 for an embodiment of the present invention asks is, for example, “Do you provide service to the area code of the destination facsimile machine?” If the main server 38 at the centralized communications center 12 tells the local router 32, for example, “Yes, the customer is valid” and “Yes, we provide service to that point of destination,” the faxbox 36 then reconnects the telephone line to the sending facsimile machine 14. The faxbox 36, at that point, in effect drops off the line and is not required any more. The router 32 then produces the facsimile tones necessary to receive the facsimile from the sending facsimile machine 14. The facsimile is then stored in the local router 32.

At this point, the facsimile is completely received by the local router 32 for an embodiment of the present invention. That router 32 already knows where the facsimile must be delivered because it validated the destination before it even accepted the facsimile. Once the facsimile is completely received, the sending router 32 transmits the entire package of received facsimile data to the receiving router 44, which is located in the city, for example, in local calling area 4, where the facsimile is going to be delivered. The sending router 44 stores the entire facsimile as it is received. Once the facsimile is completely received, the receiving router 44 then calls a local number in local calling area 4—the local destination facsimile machine's telephone number—and delivers the facsimile to the receiving facsimile machine 42.

A significant difference between the faxbox, for an embodiment of the present invention, and conventional call diverter devices is that the faxbox is programmed with an account number and has the ability to validate a call through the central computer 38. Conventional call diverter devices do not have this capability. The faxbox detects a long-distance number, routes that call into the local router and validates certain customer information before permitting the facsimile transmission to continue.

In an embodiment of the present invention, if a person were to dial the router, such as router 32 in local calling area 2, directly, the person could simulate the faxbox, such as faxbox 36 or 38, by dialing the person's account number and asking for validation. The faxbox does that for them. Instead of simply transferring the call, the faxbox passes the call through the router 32, which is programmed to automatically identify and validate the account number of the faxbox. This function is not possible with conventional call diverter devices and is a significant aspect of the present invention.

In an embodiment of the present invention, all of the activity of the facsimile machine, for example sending facsimile machine 14, such as how many facsimiles have been sent, where they went, and the like, is stored within a user's account at the centralized communications center 12. A periodic report and account statement is then sent to the user. The cost of sending long-distance facsimiles with an embodiment of the present invention can be a fraction of the cost using normal long-distance telephone service.

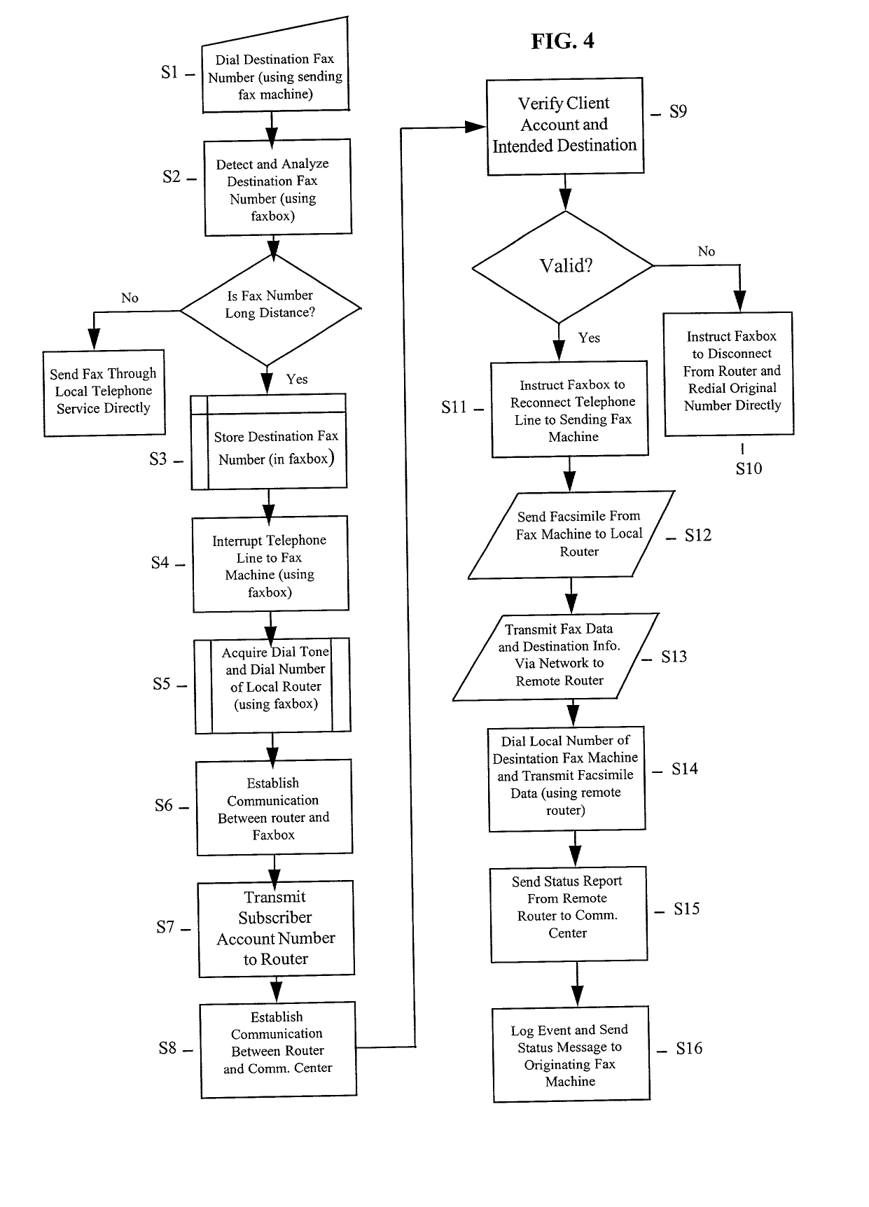

FIG. 4 is a flow chart which illustrates an example of the facsimile transmission aspect process for an embodiment of the present invention. Referring to FIG. 4, using the example of a transmission from facsimile machine 14 in local area 2 to receiving facsimile machine 42 in local calling area 4, when a user attempts to dial a long-distance number from his or her facsimile machine 14 at S1, the faxbox 36 detects the long-distance number at S2, and stores the number dialed at S3. Upon detection and storage of a complete long-distance telephone number, the faxbox 36 interrupts the telephone line 22 at S4, thus disconnecting the user's facsimile machine 14 from its originally intended call. At S5, the faxbox 36 then acquires a fresh dial tone, while keeping the facsimile machine 14 disconnected, and then dials a local telephone number, which is stored within its non-volatile memory, to the designated router 32 at S6.

Referring further to FIG. 4, when the router 32 answers the incoming call via any one of its line cards at S7, the faxbox 36 transmits to the router its subscriber account number using standard DTMF tones. After receiving a complete subscriber account number, at S8, the router 32 contacts the centralized communications center 12 via the computer network 10 to verify, at S9, that the client account is valid and active and whether the intended destination of the facsimile is within the local service area 2. At S10, if the intended destination of the facsimile is not within the local service area 2, or if the subscriber's account is not valid or in good standing, the centralized communications center 12 instructs the faxbox 36 via the router 32 to disconnect from the router and redial the original number directly.

Referring again to FIG. 4, at S11, if the subscriber's account is validated, the centralized communications center 12 instructs the faxbox 36 via the router 32 to enable communication to the facsimile machine 14, which, up to this point, has been held off-line by the faxbox. At this time, at S12, the router 32 begins communicating with the facsimile machine 14, and receiving the facsimile. At S13, once the facsimile has been successfully received, the router 32 transmits the received facsimile data, as well as the destination telephone number, via the computer network 10, to a router 44, which is located within the local calling area 4 of the destination facsimile machine 42, or as directed by the centralized communications center 12.

Referring once again to FIG. 4, when the router 44 receives a facsimile for delivery within its calling area 4, at S14, it selects a telephone line and instructs the line card to dial the local telephone number of the destination facsimile machine 42. When the destination facsimile machine answers 42, the router 44 transmits the facsimile data. Upon completion of a delivery attempt, whether successful or unsuccessful, at S15, the router 44 sends the resulting status to the centralized communications center 12. Once the centralized communications center 12 receives a result message, at S16, it then takes whatever action is necessary or designated. This action can be simply to log the event to the subscriber's history, or in the case of an unsuccessful delivery, the action can be to send the originating facsimile machine 14 an error message.

Another aspect for an embodiment of the present invention, relates to an improved alarm system monitoring system. There are, for example, numerous alarm system monitoring companies located throughout the U.S. that monitor alarm systems, not only in their local areas but across the country as well. For example, a central station in Naples, Fla., may be monitoring accounts in Michigan. When an alarm system calls in from Michigan to Naples, the call must either be made with a 1-plus call or on an 800 number. Thus, the call results in long-distance charges from Michigan to Naples. In most cases, the alarm dealer uses an 800 number rather than to chance disputing charges that may appear on a subscriber's telephone bill.

In an alarm transmission aspect for an embodiment of the present invention, as used herein, the terms “subscriber,” “alarm dealer,” “router,” and “central station” have the following meanings and/or functions. The term “subscriber” means an individual who contracts the services of an alarm dealer or central station. An “alarm dealer” is a company or individual who performs a variety of alarm-related contracting services to its or his subscribers, including sales, installations, maintenance, and the 24-Hour Monitoring of such alarms.

Alarm dealers sub-contract the actual monitoring services from a central station at wholesale rates. A dealer is the person who installs the alarm and is basically a middleman between the subscriber and the central Station. A dealer typically installs an alarm and bills the subscriber a retail amount for monitoring the alarm system. The dealer pays the central station a portion of the monitoring fee. The term “central station” refers to the building that contains alarm receiving and processing equipment and the personnel to monitor this equipment and respond accordingly to an alarm event when it occurs.

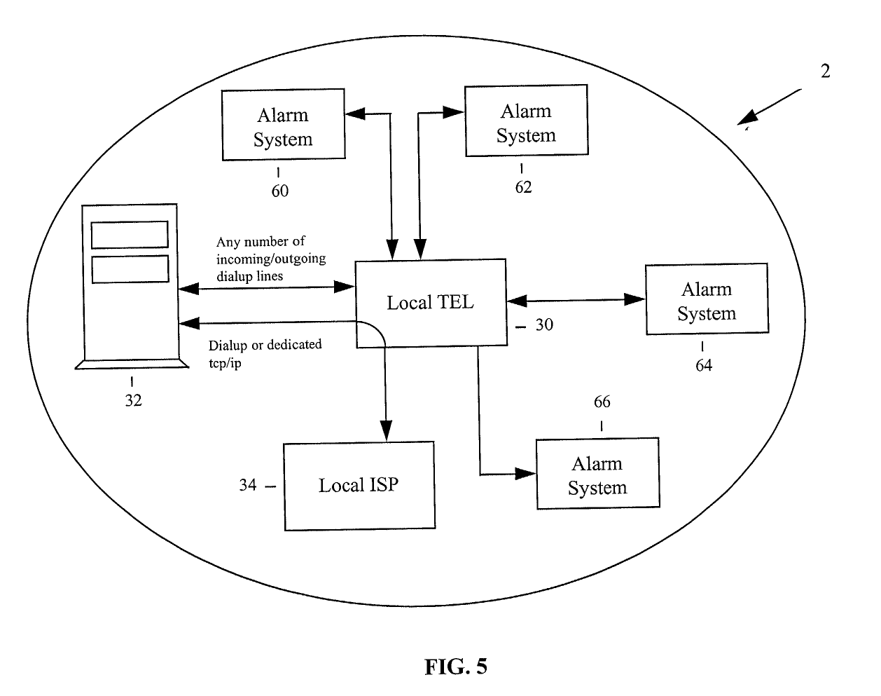

FIG. 5 is a schematic flow chart which amplifies and provides further detail regarding an example of key components and the flow of information between key components within the local calling areas shown in FIG. 1 for an alarm transmission aspect of an embodiment of the present invention. Referring to FIG. 1, an alarm transmission aspect of an embodiment of the present invention includes one or more of the local calling areas, such as local calling areas 2, 4, 6, and 8, coupled over network 10 to centralized communications network 12.

Referring to FIG. 5, each local calling area, such as local calling area 2, includes, for example, one or more alarm systems 60, 62, 64, 66 connected via telephone lines to the local telephone system 30. Each local calling area also includes, for example, at least one router 32 and at least one network service provider 34. It is to be understood that the facsimile transmission and alarm-related transmission aspects of an embodiment of the present invention are not mutually exclusive, and that both aspects can be included within the same local calling area using at least some of the same key components.

In the alarm transmission aspect for an embodiment of the present invention, the router 32 is the equipment located within a local calling area, such as local calling area 2, which receives calls directly from alarm systems, such as alarm systems 60, 62, 64, 66, in a way that is similar to the way it receives a facsimile call from a facsimile machine in the facsimile transmission aspect for an embodiment of the present invention.

Also, in the alarm transmission aspect for an embodiment of the present invention, the centralized communications center 12 includes the central office, computer equipment 38, and personnel required to manage all network operations. The primary function of the central computer equipment and database 38 is to manage all point-to-point communication between routers and to handle client-related administrative operations, such as accounting, and usage limitations.

A common feature that alarm central stations provide to their dealers is a report indicating when a customer's alarms are turned on and off (i.e., an “opening and closing report”). A dealer is the person who installs the alarm and is basically a middle-man between the customer and the central station. A dealer typically installs an alarm and bills a customer a retail amount for monitoring the alarm system. The dealer pays the central station provider a portion of that monitoring fee. The central station typically prints the reports and mails them to the dealers who in turn passes them on to their subscribers.

The alarm dealer in Michigan could provide customers an opening and closing report. The report notes every time a subscriber turns their alarm on or off and by whom. The alarm calls in to the central station and logs, for example, “User ID number turned the alarm system on at this time” or “User ID number turned the alarm system off at this time.” The subscriber, in the case of a commercial alarm system, receives a periodic printout, such as a monthly, weekly, or daily printout, of what time their employees open their business (and turn the alarm off), and what time their employees close the business (and turn the alarm on).

Another common feature that alarm central stations provide is a report indicating a major failure within the subscriber's alarm system. This report is called a “Failure to Test” report. The alarm system calls in a daily self-test to the central station, which is confirmation that the system is working properly. Upon failure to receive this call upon its regularly scheduled interval, the central station then takes action to determine the cause of the failure. The action taken may be to notify the dealer that service call is required.

However, if the central station in Naples, Fla., is monitoring accounts in Michigan, the reporting system might require, for example, a hundred phone calls a month from every single subscriber. The system calls in a daily self-test which is confirmation that the system is working, plus one opening a day and one closing a day. A dealer with only 500 accounts would typically incur toll charges on over 50,000 long-distances calls every month. The daily self-test calls, plus one opening a day and one closing a day, or more. Those long-distance charges can add up quickly.

If the central monitoring station is long-distance to a dealer, the dealer often will elect to not supply customers with self-tests, opening and closing, and other activity reports, and thus, not enable the opening, closing, and self-test features within a subscriber's alarm system. To minimize long-distance charges, the customers' alarms might be set to only transmit, for example, burglaries, fires, or other emergency events to the central station. The costs of hundreds or thousands of long-distance calls a month are often too prohibitive for other transmissions that have become accepted within the industry as non-essential.

Referring further to FIGS. 1 and 5, using the example of alarm system 60 in local area 2, the router 32 for the alarm transmission aspect of an embodiment of the present invention, in a way that is similar to the way it receives a facsimile call from a facsimile machine, can receive calls directly from alarm systems, such as alarm system 60. For example, alarm system 60 can call a telephone line on the router 32, and the router is designed and programmed to accept an alarm message from the alarm system. The router 32 then transmits the message back to the centralized communications center 12. The local calling areas all over the country, such as local calling areas 2, 4, 6, or 8, set up with routers, such as router 32 in local calling area 2, can accept not only facsimile calls, but also free alarm signals from anywhere that a router is set up.

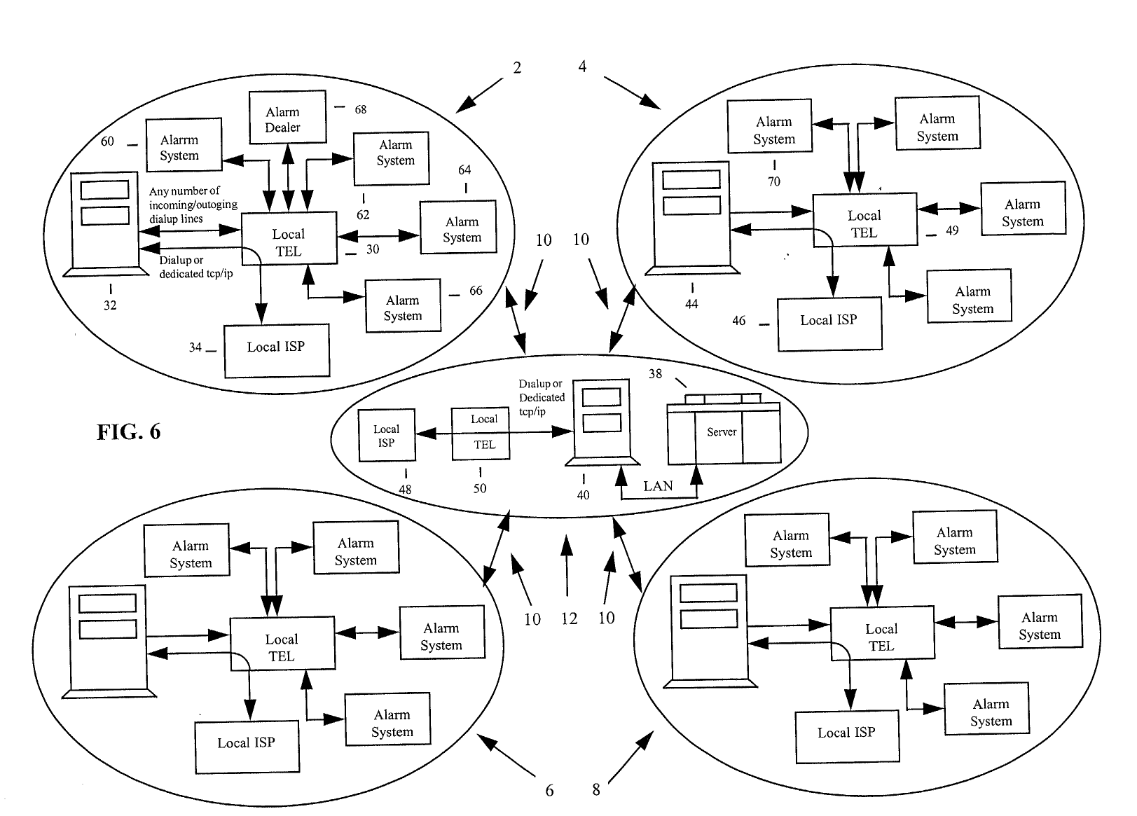

In addition, the router, such as router 32, for an embodiment of the present invention also provides a link. FIG. 6 is a schematic flow chart which amplifies and provides further detail regarding examples of key components and the flow of information between key components shown in FIGS. 1 and 5 for the alarm-related transmission aspect of an embodiment of the present invention. For example, referring to FIG. 6, an alarm dealer 68 at a PC can call the local router 32 with a modem in his or her PC, and through the same network connection 10 that the router has with the centralized communications center 12, the dealer can go online basically with the centralized communications center software and access any accounts, do billing, access whose alarm systems went on and off, and access the database 38 on a 24-hour-a-day basis through the local router or by connecting directly to any ISP.

In an embodiment of the present invention, if the wide area computer network 10 connected to the router 32 is, for example, the Internet, the dealer 68 also has a connection to that wide area network supplied by a local area network connection 34 to the router. For example, not only does the router 32 provide the dealer 68 with 24-hour access to the central station database 12, but also allows the dealer to ‘surf’ the Internet using a commercially available web browser.

Another functionality of the router in an alarm transmission aspect for an embodiment of the present invention provides alarm reporting and alarm messaging and complete access for an alarm dealer to the local router, for example, in another calling area. For example, the dealer 68 in local calling area 2 can give subscribers in another local calling area, such as alarm system 70 in local calling area 4, a local telephone number for alarm calls. The calls go to the local router 44 in local calling area 4, and the messages go to the central station 12 for free, no matter how many calls there are. The dealer 68 at the dealer's PC can access his account at any time for free. The dealer 68 can go on-line with the central station 12 and print reports for subscribers. The computer network 10 links everything together.

In an embodiment of the present invention, if the network service provider, such as local ISP 34 in local calling area 2, goes down for any reason, the local router 32 can contact the router 40 in the centralized communications center city 12 directly. If the network link 10 goes down in a given city, such as local calling area 2, as a result, for example, of a casualty occurrence, such as a fire, at the facility of network service provider 34, or the phone lines get cut to the network service provider, that router 32 can use any of its other phone lines to contact the centralized communications center 12 directly. If any router in a local calling area, such as local calling areas 2, 4, 6, or 8, loses contact with the network 10, the local router for the particular calling area can use a phone line and call long-distance directly to establish communication with the centralized communications center 12. If a router fails completely, the local telephone company will automatically forward all incoming alarm voice and fax calls directly to a pre-programmed number for a pre-determined router for automatic back-up purposes.

Using the example of local calling area 2, another functionality of the local router 32 for an embodiment of to the present invention is that it provides a voice terminal to the central station database 38. The line cards connected to the router 32 can be set up to answer in different modes. For example, some lines can answer in a mode, or modes, such as with a tone or sequence of tones, that will allow them to accept signals from or communicate with alarm systems, such as alarm systems 60, 62, 64, or 66. Other line cards can be programmed, for example, to answer with a voice message prompting the caller to make a selection from a menu of options.

In an embodiment of the present invention, the functions within the menu of options include, for example, Call Transfer, and Voice Terminal functions. With respect to the Call Transfer function, through a feature supplied by the local telephone company, such as local telephone company 30, the caller can choose an option on the menu which causes the line card to transfer the call to another telephone number. For example, the menu option might say “For sales press one” and if the caller presses the number one on his telephone, the line card transfers the call to the sales department which can be anywhere in the country. The transfer is accomplished by sending the call back to the local telephone company 30, and once the transfer is completed, the line card will no longer be connected to the caller.

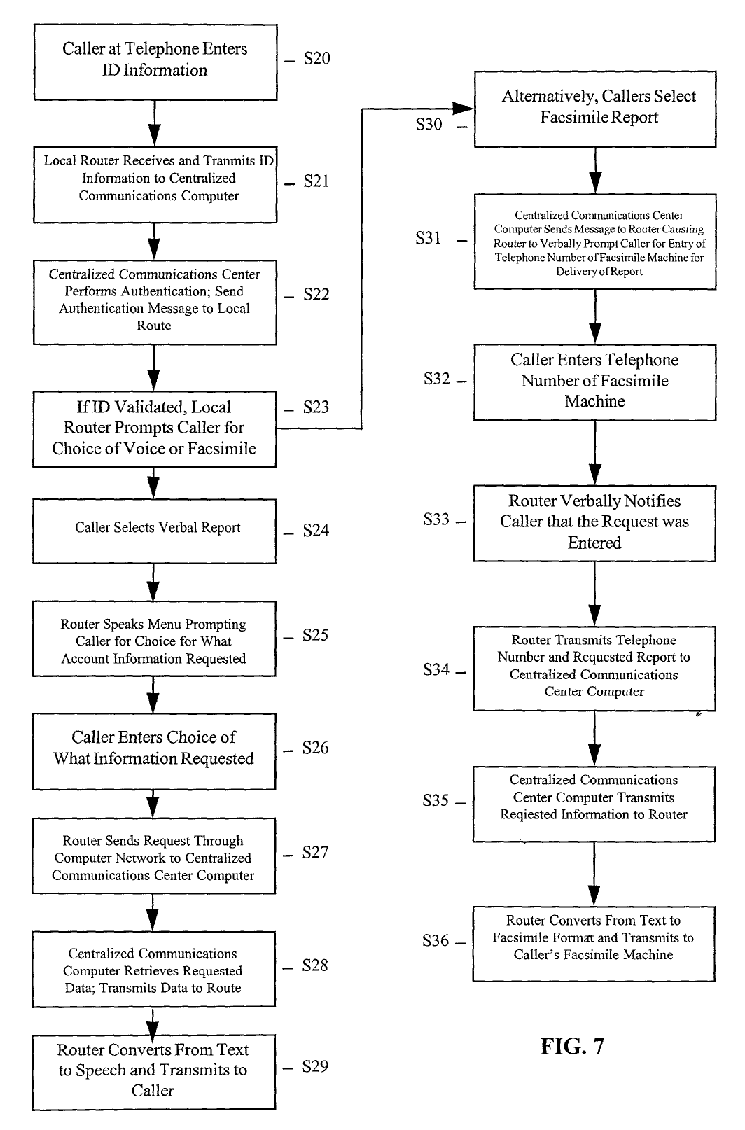

The Voice Terminal function for an embodiment of the present invention allows the caller to access account information from a touch tone telephone and to have the requested information delivered verbally or by facsimile transmission upon demand. FIG. 7 is a flow chart which illustrates an example of the account access process for the alarm-related aspect of an embodiment of the present invention. Referring to FIG. 7, at S20, using a tone dial telephone, the caller must enter identification such as the caller's account number or main telephone number and secret pass code. Using the example of local calling area 2, at S21, the local router 32 receives and transmits this information through the computer network 10 to the centralized communications computer 38 for authentication. At S22, the centralized communications center computer 38 performs an authentication and sends back a message to the router 32 indicating whether or not the account information and pass code was valid.

If successfully validated, at S23, the router 32 for an embodiment of the present invention then begins to play a verbal menu prompting the caller to choose how the requested information is to be delivered, by voice or facsimile. For example, the prompt might say “For verbal reports, press one. For faxed reports, press 2.” At S24, the caller makes a selection, for example, of verbal report, and, at S25, the router 32 then begins playing a verbal menu prompting the caller to choose from a list of options to determine exactly what part of their account information the caller wishes to access. The menu prompt can include options, such as “To review your alarm history or opening and closing information, press one. For your account balance or payment history, press 2.” The menu options available are far more detailed and abundant than the examples given.

In an embodiment of the present invention, at S26, the caller completes the necessary choice or choices to specify what information is being requested, and, at S27, the router 32 sends the request through the computer network 10 to the centralized communications computer 38. At S28, the centralized communications center computer then retrieves the requested data and transmits it to the appropriate router. If the requested information is to be delivered verbally, the centralized communications computer 38 transmits the data back to the router 32 that requested the data, where the data is then converted from text data to speech, using industry standard methods, and verbally delivered to the caller.

In an embodiment of the present invention, alternatively, at S29, if a facsimile delivery method has been requested, at S30, the centralized communications center computer 38 sends a message to the router 32 causing the router to verbally prompt the caller to enter the telephone number of the facsimile machine where the report is to be delivered, such as facsimile machine 20 shown in FIG. 3. At S31, the caller enters the complete area code and telephone number where the report is to be sent, and, at S32, the router 32 verbally notifies the caller that the request has been made and the fax will be delivered shortly. At S33, the router 32 then transmits the telephone number and requested report message to the centralized communications center computer 12 using the computer network 10.

In an embodiment of the present invention, at S34, the centralized communications center computer 38 transmits the requested information to the router 32 using the computer network 10, where, at S35, it is then converted from text to facsimile format and transmitted to the destination facsimile machine 20 specified by the caller. The router 32 uses, for example, either a line card or commercially available fax modem to place the call and transmit the facsimile.

Upon receipt of a facsimile request, in an embodiment of the present invention, the centralized communications center computer 38 first attempts to find an available router within the local calling area where the facsimile is to be delivered. If the centralized communications center 12 does not find any working routers available within the local calling area of the destination of the facsimile, the centralized communications center can pass the requested information to any other router it chooses for delivery.

In an embodiment of the present invention, the methods for choosing a router are based on a data table stored within the centralized communications center computer 38 that contains all the area codes and prefixes handled by all the routers connected to the computer network 10. Choosing a router is also based on the availability, functional status, and load calculations of the routers within that data table. If no routers are determined to be available within a local calling area of where the facsimile is to be sent, a router outside that local calling area may have to dial a long-distance number to deliver the report. Placing a toll call to deliver the requested report is preferred over the report not being delivered at all.

In addition to fax-on-demand reports, in an embodiment of the present invention, a subscriber may wish to have scheduled reports sent via fax, for example, of account history, alarm, or opening and closing events. The subscriber's account data within the centralized communications center computer 38 contains the types of reports that are to be delivered, the schedule for delivery, and the telephone number to which the facsimile is to be sent. The dealer, the central station, or centralized communications center 12 can modify this data. When a scheduled facsimile event occurs, the centralized communications center computer 38 transmits the specified report data to a router for delivery in the same manner as a fax-on-demand report previously described.

By previously available methods, there is no way for subscribers' alarms, including opening and closing and self-test signals, to reach the central station without a toll charge, when the subscriber is outside the local calling area of the central station. Nor can the central station deliver the received information to the dealer or subscriber via telephone or facsimile without a toll charge, when the subscriber or dealer is outside the local calling area of the central station.

An embodiment of the present invention effectively eliminates all toll charges to and from the central station. Virtually unlimited alarm signals can be sent to the central station's alarm processing equipment, where it can be processed and retransmitted to dealers and subscribers, or retrieved by dealers and subscribers, without any toll or per-event charges. In addition to eliminating nearly all toll charges between central stations and their dealers and subscribers, an embodiment of the present invention also significantly reduces the primary labor costs associated with central stations, while in yet another way, performs to eliminate the toll charges from a central station to its subscribers.

When an alarm occurs, the central monitoring station must have some way of determining whether or not the alarm is real and whether some type of emergency action should be taken, or if the alarm was in error, such as caused by the subscriber. The most common method for verifying false alarms is when the central station personnel, upon receipt of an alarm, telephone the subscriber and requests verification of a ‘secret’ code that is stored within the subscriber's account information. If the code which the subscriber gives matches the code on file, no action is taken and the central monitoring station personnel disregard the alarm.

This method of verification uses valuable central monitoring station personnel that could otherwise be performing tasks with a higher priority, such as dispatching actual alarms to the proper authorities. When a subscriber that caused a false alarm is waiting for a telephone call from the central monitoring station, a strain is placed on the entire system, especially during peak periods where there is a high volume of alarm activity. There are often more alarms during peak periods than there are operators to promptly handle the verification process, which can significantly delay the phone call placed to the subscriber, and ultimately to the authorities, when the alarm is real. A subscriber who may not receive a call in what the subscriber feels is a timely manner is likely to cancel or change monitoring companies, and since their perceived monitoring company is their dealer, the dealer will lose the subscriber as well.

An embodiment of the present invention provides, for example, at least three methods of false alarm verification, without the need for toll calls or the cost or potential delay associated with central station personnel. One method is referred to herein as the callback method, in which after an alarm has been received by the central station's alarm processing equipment, instead of a phone call being placed to the subscriber by the central station personnel, the call is placed from the router within the subscriber's local calling area. Because the call is now being placed from within the subscriber's local calling area, the toll charges from the central station 12 have been eliminated. The callback method of false alarm verification also eliminates the potential for human error and delays, as the call is now being handled by an automated system whose capacity is determined only by the number of inexpensive telephone lines connected to each router and the number of routers on the computer network.

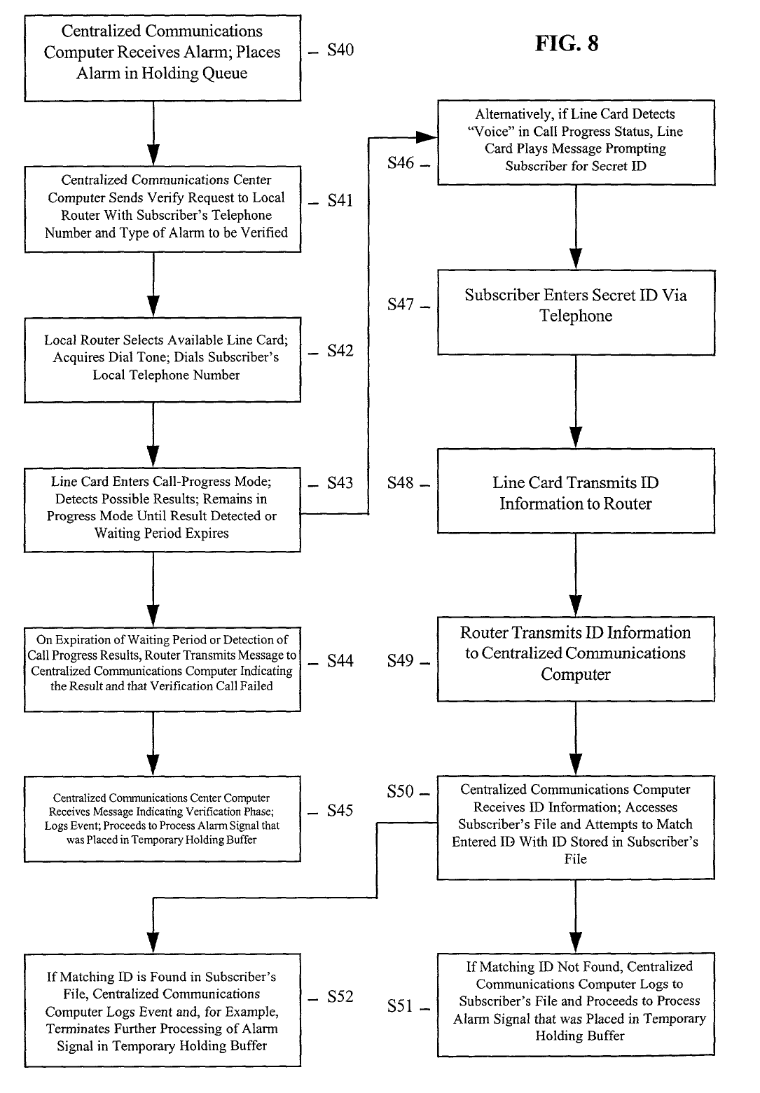

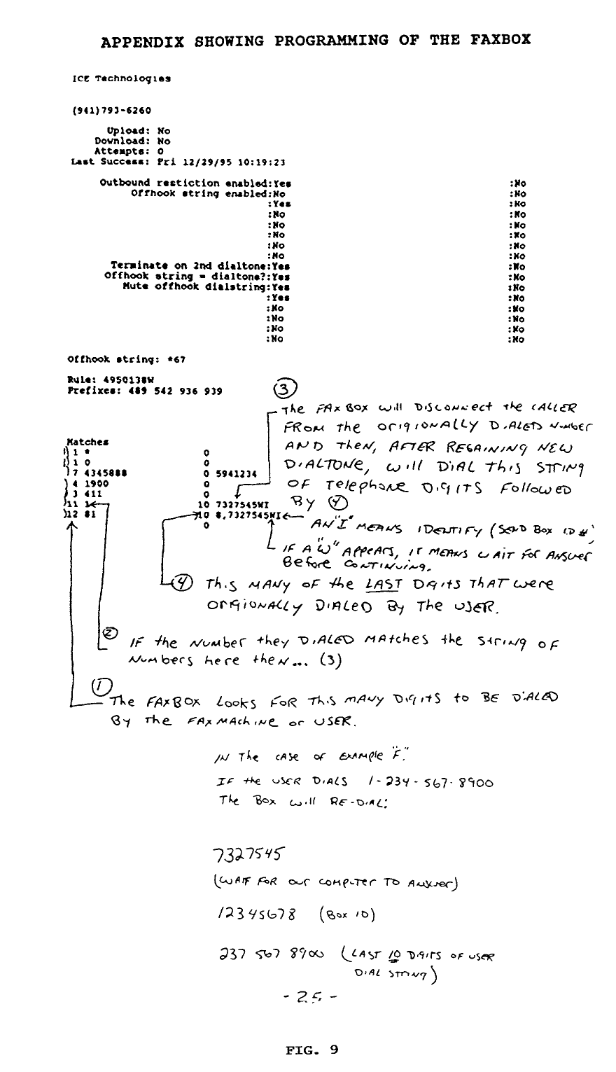

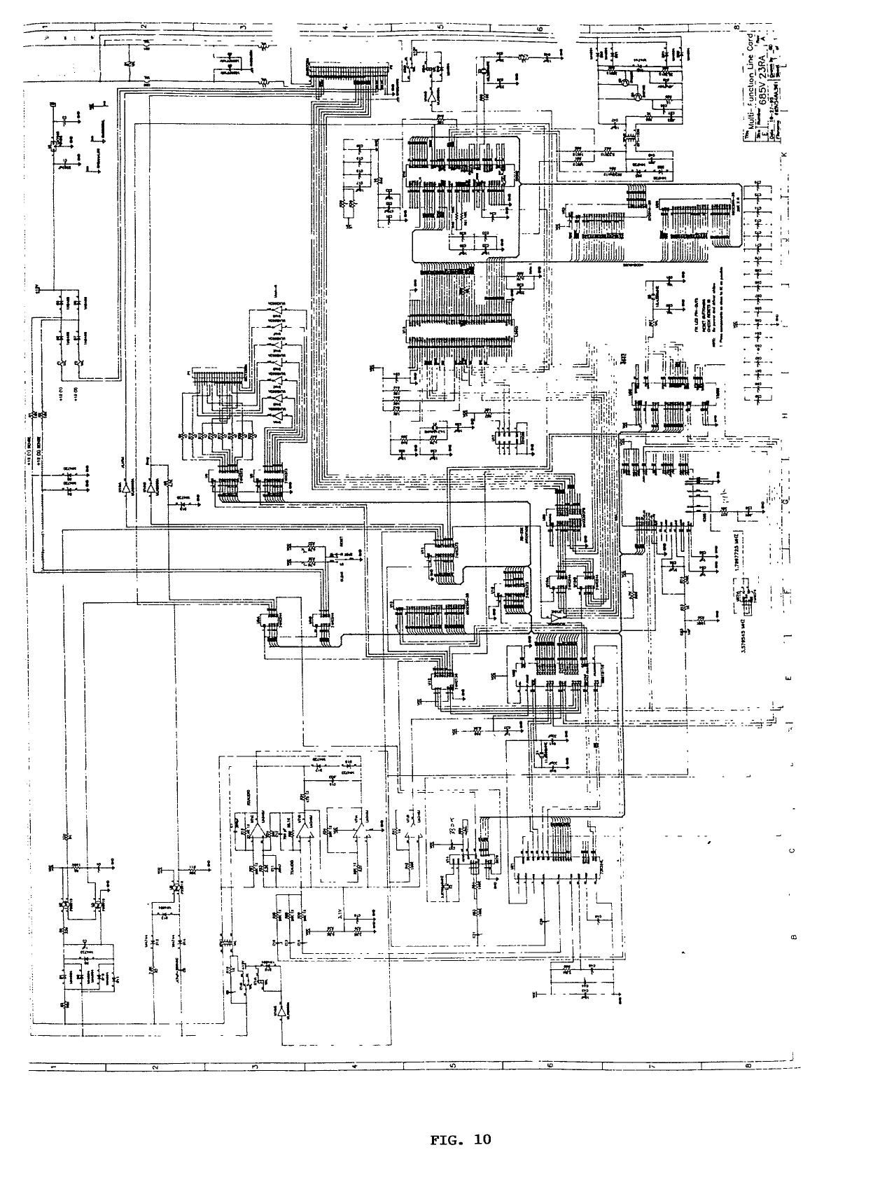

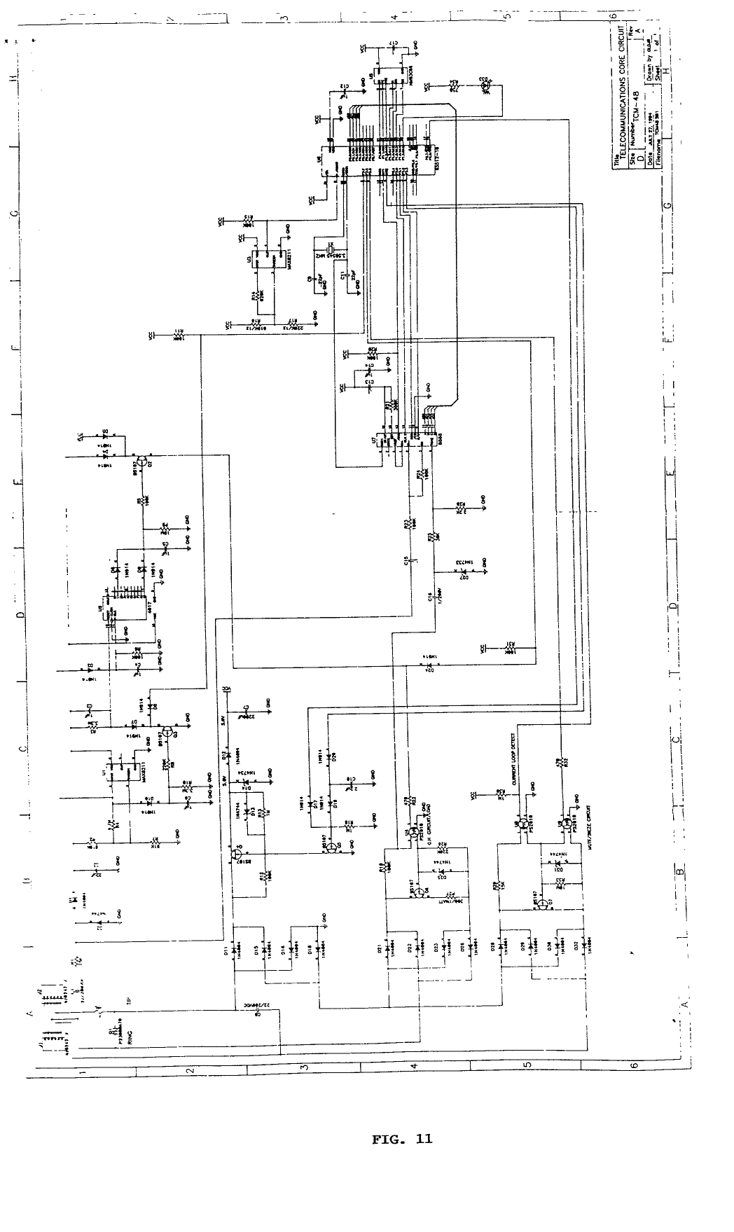

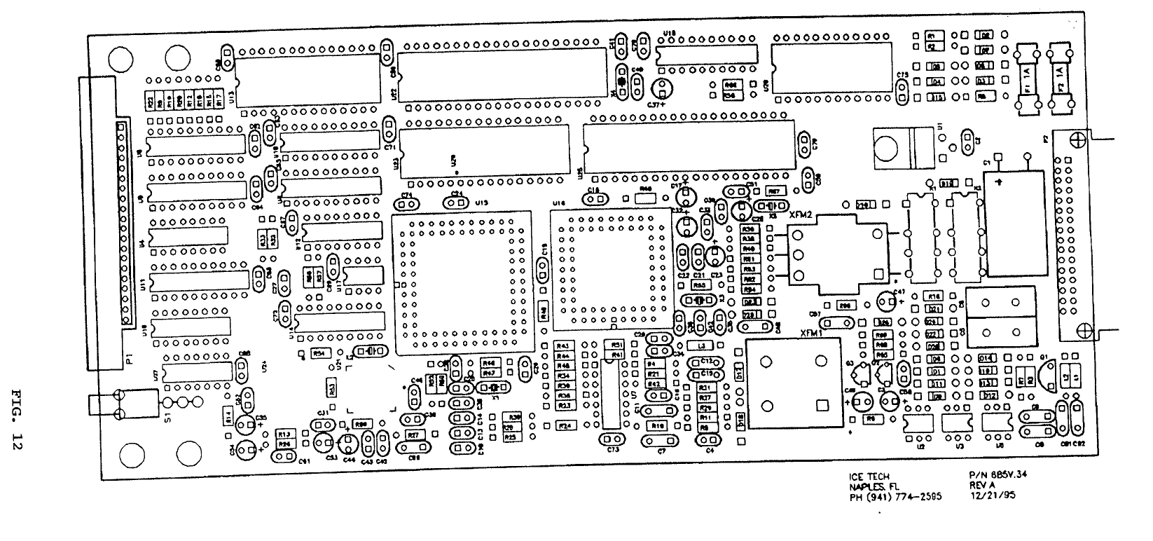

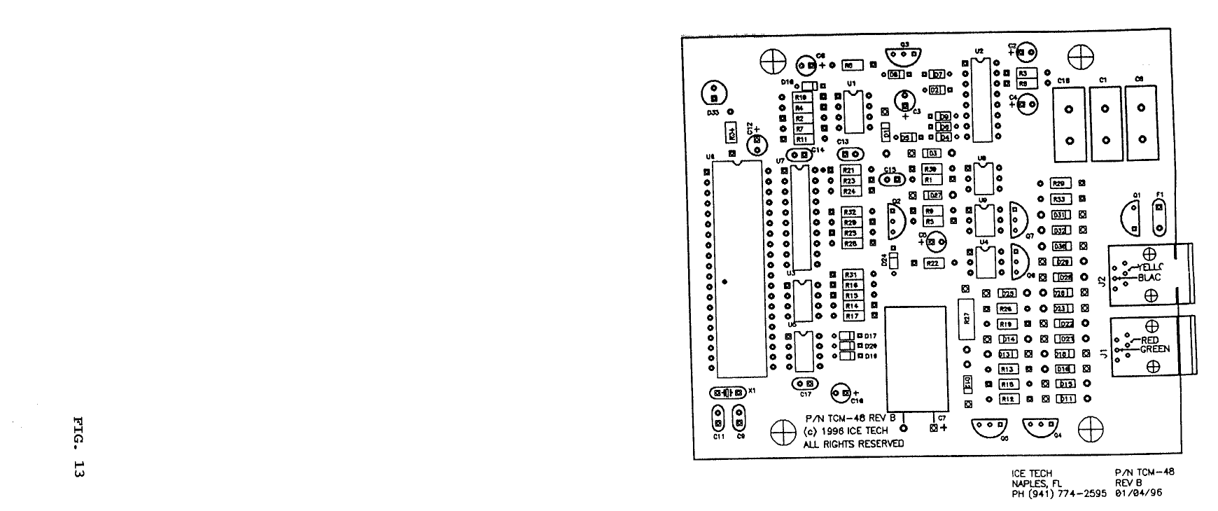

FIG. 8 is a flow chart which illustrates an example of the callback false alarm verification process for the alarm-related transmission aspect of an embodiment of the present invention. Referring to FIG. 8, at S40, the centralized communications computer 38 receives an alarm, for example, from alarm system 60 in local calling area 2, and the alarm is placed in a temporary buffer, or holding queue, where no further processing of the alarm signal occurs until the verification process with the subscriber has been competed. At S41, the centralized communications computer 38 sends the verify request to the router 32 within the subscriber's local calling area 2 along with the telephone number of the subscriber and the type of alarm to be verified. At S42, the local router 32 selects an available line card, acquires a dial tone, and dials the subscriber's local telephone number.

Referring further to FIG. 8, at S43, the line card enters a call-progress mode that detects a number of possible results that may occur after dialing has been completed. These call progress results can include, for example, busy, ring-no-answer, voice answer, and answering machine detect. The line card remains in call progress mode until one of these results has been detected or until a predetermined waiting period has expired. At S44, upon expiration of this waiting period, or detection of one of the call progress results, such as busy signal, answering machine detect, or ring-no-answer, the router 32 transmits a message to the centralized communications computer 38 indicating this result and that the verification call has failed.

Referring again to FIG. 8, at S45, the centralized communications center computer 38, upon receipt of a message indicating a verification failure, logs this event to the subscriber's history file within the centralized communications computer database 38 and proceeds to process the alarm signal that was placed in the temporary holding buffer. Alternatively, at S46, if the line card detects a “voice” call progress status, (i.e., the subscriber answered the phone), the line card begins to play a message indicating to the subscriber the type of call and prompts the subscriber to enter the subscriber's secret ID. At S47, the subscriber enters his or her secret numeric password via a tone dial telephone, and, at S48, the line card transmits the information through to the router 32, which, at S49, transmits this information through the computer network 10 to the centralized communications computer 38.

Referring still further to FIG. 8, at S50, the centralized communications center computer 38, upon receipt of the subscriber's secret numeric code, accesses the subscriber's file and attempts to match the code that was entered with one of those stored within the subscriber's file. At S51, if a matching secret code is not found in the subscriber's file, (i.e., an incorrect secret code was entered by the subscriber) the centralized communications computer 38 logs the event to the subscriber's file and proceeds to process the alarm signal that was placed in the temporary holding buffer. At S52, if a matching secret code was found in the subscriber's file (i.e., a correct secret code was entered by the subscriber), the centralized communications computer 38 logs the event and in most cases terminates any further processing of the alarm signal that was placed in the temporary holding buffer.

A second method of false alarm verification for an embodiment of the present invention is referred to as subscriber call-in. The operation of the subscriber's call-in false alarm verification process is essentially the same as the call-back verification process previously described with one major difference. That difference is that instead of the call being placed from the router 32 to the subscriber, the subscriber is required to call in to a line card on the router within the subscriber's local calling area. A third method of false alarm verification is by utilizing opening/closing reporting from the subscriber to the central station 12, which virtually eliminates all toll charges.

In an embodiment of the present invention, the voice terminal can receive calls from subscribers over the local telephone lines. An embodiment of the present invention allows for any number of routers, central stations, or subscribers to be connected to the computer network 10. The router, for an embodiment of the present invention does not need to receive alarms to function. For example, the router 32 can function as an auto attendant, the router can have standard alarm receivers connected to it, if the router or line cards, or computer network fail, lines busy out. The telephone lines are forced to a busy state, and the service feature provided by the local telephone company will automatically forward all calls to a back-up telephone number, such as the router located within the central communications center. A key element with respect to alarm signals is that in the event of a complete or partial failure of a router, no alarm signals will be lost or delayed.

Various preferred embodiments of the invention have been described in fulfillment of the various objects of the invention. It should be recognized that these embodiments are merely illustrative of the principles of the present invention. Numerous modifications and adaptations thereof will be readily apparent to those skilled in the art without departing from the spirit and scope of the present invention. Accordingly, the invention is only limited by the following claims.

What is claimed is:

1. A method for redirecting long distance telephone transmissions over a computer network, comprising:
receiving a telephonic message directed to an intended destination;
automatically associating the message with a sender account; and
automatically directing the message to the intended destination over a computer network.

2. The method of claim 1, wherein receiving the telephonic message further comprises receiving the message by a local router.

3. The method of claim 2, wherein receiving the message by the local router further comprises receiving message from a local facsimile machine.

4. The method of claim 3, wherein receiving the message by the local router further comprises receiving the message from the local facsimile machine coupled to a faxbox.

5. The method of claim 4, wherein receiving the message from the facsimile machine coupled to the faxbox further comprises automatically identifying a long distance aspect of the intended destination of the message.

6. The method of claim 2, wherein receiving the message by the local router further comprises receiving message from one of an alarm system, an alarm system subscriber, and an alarm system dealer.

7. The method of claim 5, wherein automatically identifying further comprises automatically identifying the long distance aspect of the intended destination of the message by the faxbox coupled to the local facsimile machine.

8. The method of claim 7, wherein automatically identifying further comprises automatically storing information related to the long distance aspect of the intended destination by the faxbox.

9. The method of claim 7, wherein automatically identifying further comprises automatically interrupting a telephone line to the local facsimile machine by the faxbox.

10. The method of claim 9, wherein automatically identifying further comprises automatically establishing communication by the faxbox to the local router.

11. The method of claim 10, wherein automatically identifying further comprises automatically transmitting information related to the intended destination by the faxbox to the local router.

12. The method of claim 11, wherein automatically identifying further comprises automatically establishing communication by the local router to a centralized communications center server.

13. The method of claim 12, wherein automatically identifying further comprises automatically forwarding the intended destination information by the local router to the centralized communications center server.

14. The method of claim 13, wherein automatically identifying further comprises automatically verifying the long distance aspect by the centralized communications center server from the intended destination information.

15. The method of claim 1, wherein automatically associating the message with the sender account further comprises receiving sender account information related to the message by a faxbox.

16. The method of claim 15, wherein receiving the sender account information by the faxbox further comprises receiving the sender account information related to the message by the faxbox coupled to a local facsimile machine.

17. The method of claim 16, wherein automatically associating further comprises automatically transmitting the sender account information by the faxbox to a local router.

18. The method of claim 17, wherein automatically associating further comprises automatically establishing communication by the local router to a centralized. communications center server.

19. The method of claim 18, wherein automatically associating further comprises automatically transmitting the sender account information by the local router to the centralized communications center server.

20. The method of claim 19, wherein automatically associating further comprises automatically verifying the sender account from the sender account information by the centralized communication center server.

21. The method of claim 1, wherein automatically associating further comprises receiving sender account information related to the message by a local router.

22. The method of claim 21, wherein automatically associating further comprises automatically establishing communication by the local router to a centralized communications server.

23. The method of claim 22, wherein automatically associating further comprises automatically transmitting the sender account information by the local router to the centralized communications center server.

24. The method of claim 23, wherein automatically associating further comprises automatically verifying the sender account corresponding to the sender account information by the centralized communications server.

25. The method of claim 1, wherein the computer network further comprises the Internet.

26. The method of claim 1, wherein automatically directing further comprises receiving the message by a centralized communications center server.

27. The method of claim 26, wherein receiving the message further comprises receiving the message by centralized communications server from a local router.

28. The method of claim 27, wherein receiving the message further comprises receiving the message by the centralized communications server from the local router over the computer network.

29. The method of claim 28, wherein receiving the message further comprises receiving the message by the local router from a local facsimile machine.

30. The method of claim 26, wherein automatically directing further comprises automatically transmitting the received message by the centralized communications server to a remote router.

31. The method of claim 30, wherein automatically transmitting further comprises automatically transmitting the received message by the centralized communications server to the remote router over the computer network.

32. The method of claim 31, wherein the computer network further comprises the Internet.

33. The method of claim 34, wherein automatically directing further comprises automatically transmitting the received message by the remote router to a remote facsimile machine.

34. The method of claim 33, wherein automatically directing further comprises automatically sending a status report relating to the received message by the remote router to the centralized communications center server.

35. The method of claim 34 wherein automatically sending the status report further comprises automatically sending the status report by the centralized communications server to the local facsimile machine.

36. The method of claim 1, further comprising automatically transmitting information related to the sender account over the computer network.

37. The method of claim 36, wherein automatically transmitting the information further comprises automatically transmitting the information by a centralized communications server to a local router.

38. The method of claim 37, wherein automatically transmitting the information further comprises receiving a request for the information by the centralized communications server from the local router.

39. The method of claim 38, wherein automatically transmitting the information further comprises automatically transmitting the information by the local router to one of a telephone receiver and a facsimile machine.

40. The method of claim 1, further comprising automatically transmitting an alarm system message over the computer network.

41. The method of claim 40, wherein automatically transmitting the alarm system related message further comprises automatically transmitting the alarm system message by a local router to a centralized communications server.

42. The method of claim 41, wherein automatically transmitting the alarm system message further comprises automatically processing the alarm system message by the centralized communications server.

43. The method of claim 42, wherein automatically processing the alarm system message further comprises automatically transmitting an alarm system call-back message related to the alarm system message by the centralized communications center server over the computer network to the local router.

44. The method of claim 43, wherein automatically transmitting further comprises automatically transmitting the alarm system call-back message by the local router to a telephone receiver of one of an alarm system subscriber and an alarm system dealer.

45. A system for redirecting long distance telephone transmissions over a computer network, comprising:
means for receiving a telephonic message directed to an intended destination;
means coupled to the receiving means for associating the message with a sender account; and
means coupled to the associating means for directing the message to the intended destination over a computer network.

46. The system of claim 45, wherein the receiving means further comprises a local router.

47. The system of claim 46, wherein the receiving means further comprises a local facsimile machine coupled to the local router.

48. The system of claim 47, wherein the receiving means further comprises a faxbox coupled to the local facsimile machine.

49. The system of claim 48, further comprising means associated with the receiving means for automatically identifying a long distance aspect of the intended destination of the message.

50. The system of claim 49, wherein the identifying means further comprises a local faxbox coupled to the local facsimile machine.

51. The system of claim 50, wherein the identifying means further comprises a central communications server coupled to the local router over a computer network.

52. The system of claim 45, wherein the associating means further comprises a local router.

53. The system of claim 52, wherein the associating means further comprises a central communications server coupled to the local router over a computer network.

54. The system of claim 45, wherein the directing means further comprises a central communications center server.

55. The system of claim 54, wherein the directing means further comprises a local router coupled to the central communications server over a computer network.

56. The system of claim 55, wherein the directing means further comprises a remote router coupled to the central communications server over the computer network.
